(19) United States
(12) Patent Application Publication
(10) Pub. No.: US 2024/0161116 A1
(43) Pub. Date: May 16, 2024

(54) SYSTEMS AND METHODS FOR REAL-TIME IDENTIFICATION OF AN ANOMALY OF A BLOCK OF A BLOCKCHAIN

(71) Applicant: U.S. Bank, Minneapolis, MN (US)

(72) Inventors: Ahmed Mohammed Abdelrahman Mohammed, Dallas, TX (US); Michael Jude Villano, Laguna Niguel, CA (US); Samuel Ayalew Assefa, Boston, MA (US)

(73) Assignee: U.S. Bank, Minneapolis, MN (US)

(21) Appl. No.: 17/987,341

(22) Filed: Nov. 15, 2022

(51) Int. Cl. G06Q 20/40

(52) U.S. Cl. CPC G06Q 20/4016; G06Q 2220/00

(57) ABSTRACT

Systems and methods to identify blockchain anomalies include an artificial intelligence (AI) tool comprising a processor and an AI model, a memory communicatively coupled to the processor, and machine-readable instructions stored in the memory. Upon execution by the processor, the machine-readable instructions cause the processor to: extract block parameters from a block of a blockchain, generate one or more statistical approximations of the block based on the block parameters, compare the one or more statistical approximations of the block to at least one anomaly threshold, detect an irregular block pattern in the block when the one or more statistical approximations exceed the at least one anomaly threshold, via the AI model, identify an anomaly within the block based on the irregular block pattern in the block, and generate an alert when the anomaly is identified.

### TECHNICAL FIELD

The present disclosure relates to automated anomaly identification solutions and, in particular, systems and methods for real-time identification of an anomaly of a block of a blockchain using artificial intelligence solutions.

### BACKGROUND

Blockchains add blocks to a chain after proof of work and computation of a hash of the blocks to be added by a plurality of miners of distributed nodes in a de-centralized system. However, while it is extremely difficult to change an input of a blockchain of an established block, fraudulent activities may occur and be used as input that lead to a block including fraudulent data. Accordingly, a need exists for alternative solutions to determine anomalies detecting such fraudulent activities in a blockchain.

### BRIEF SUMMARY

According to the subject matter of the present disclosure, a system to identify blockchain anomalies comprises an artificial intelligence (AI) tool comprising a processor and an AI model, a memory communicatively coupled to the processor, and machine-readable instructions stored in the memory. Upon execution by the processor, the machine-readable instructions cause the processor to: extract block parameters from a block of a blockchain, generate one or more statistical approximations of the block based on the block parameters, compare the one or more statistical approximations of the block to at least one anomaly threshold, detect an irregular block pattern in the block when the one or more statistical approximations exceed the at least one anomaly threshold, via the AI model, identify an anomaly within the block based on the irregular block pattern in the block, and generate an alert when the anomaly is identified.

According to another embodiment of the present disclosure, a system to identify blockchain anomalies comprises an AI tool comprising a processor and an AI model, a memory communicatively coupled to the processor, and machine-readable instructions stored in the memory that, upon execution by the processor, cause the processor to: extract block parameters from a plurality of blocks of a blockchain, and generate one or more statistical approximations of each block of the plurality of blocks based on the respective block parameters. Upon execution by the processor, the machine-readable instructions further cause the processor to: detect an irregular block pattern in the block when the one or more statistical approximations exceed at least one anomaly threshold, determine one or more blocks of the plurality of blocks containing the irregular block pattern, via the AI model, identify an anomaly within the one or more blocks based on the irregular block pattern, and generate an alert when the anomaly is identified.

According to yet another embodiment of the present disclosure, a method to identify blockchain anomalies comprises extracting block parameters from a block of a blockchain, generating one or more statistical approximations of the block based on the block parameters, and comparing the one or more statistical approximations of the block to at least one anomaly threshold. The method further comprises detecting an irregular block pattern in the block when the one or more statistical approximations exceed the at least one anomaly threshold, via an artificial intelligence (AI) model, identifying an anomaly within the block based on the irregular block pattern in the block, and generating an alert when the anomaly is identified.

Although the concepts of the present disclosure are described herein with primary reference to an anomaly detection of a financial transaction environment, it is contemplated that the concepts will enjoy applicability to any setting for purposes of anomaly detection solutions, such as alternative business settings or otherwise.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a system including an artificial intelligence tool for use with a blockchain and the process flows described herein to detect anomalies in the blockchain, according to one or more embodiments shown and described herein;

FIG. 2 illustrates a schematic of a blockchain network including one or more nodes communicatively coupled to the artificial intelligence tool of FIG. 1;

FIG. 3 illustrates a flowchart process for use of the system of FIG. 1, according to one or more embodiments shown and described herein.

### DETAILED DESCRIPTION

In embodiments described herein and in greater detail below, an artificial intelligence (AI) tool is trained to scan extracted block data to detect and classify anomalies within a block of a blockchain to determine whether fraud or other invalidate transaction is associated with the block. The determination may be made in real-time such as during and within the time period the hash is being computed (and may be made within a second). As will be described in greater detail further below, the AI tool may be trained to detect and classify anomalies in block information, such as anomalies due to phishing/fraud activities or other financial disturbances within a block (e.g., a sudden change in gas price in listings within a block digital ledger). Blocks that exhibit anomalies may be clustered into targeted classifications. Once the anomaly is detected, an alert message can be sent out for further AI inspection, data analysis, and/or business usage. For example, a user may be informed that a fraudulent transaction has been attempted, and the user may then cancel the transaction. Alternatively, the AI tool itself may instruct an associated system to automatically prevent or hold the transaction including the anomaly. Transactions may involve the use of cryptocurrency, such as in the ETHEREUM platform, which is a decentralized, open-source blockchain including smart contract functionality and ETHER as a native cryptocurrency.

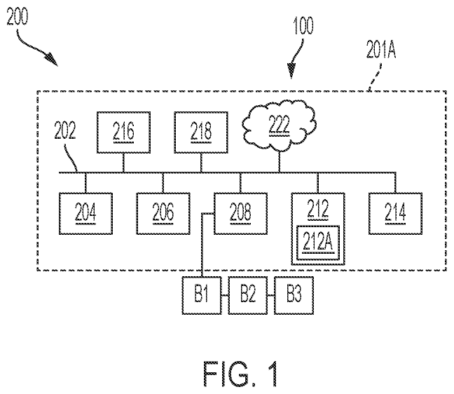

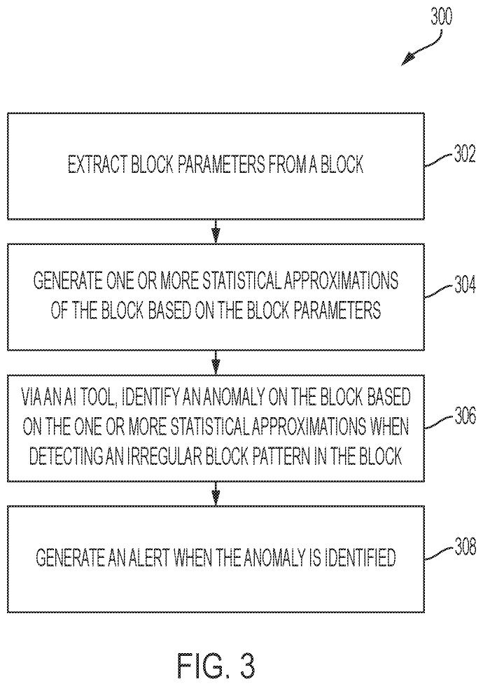

Referring to FIG. 1, an intelligent anomaly detection system 200 is illustrated for use with the processes described herein, such as a process 300 of FIG. 3, as described in greater detail below. The intelligent anomaly detection system 200 comprises an intelligent anomaly detection module 201A that may be a component of the machine learning anomaly detection model to generate one or more classifications of anomalies as described in greater detail below.

The intelligent anomaly detection system 200 further comprises a communication path 202, one or more processors 204, a non-transitory memory component 206 (e.g., memory), a blockchain network including one or more nodes 208 and a blockchain including one or more blocks B1, B2, B3 of a blockchain that can be stored in each node 208, an artificial intelligence (AI) tool 212 including an AI model 212A, a storage or database 214, a machine learning module 216, a network interface hardware 218, and a network 222. In some embodiments, the intelligent anomaly detection system 200 is implemented using a wide area network (WAN) or network 222, such as an intranet or the internet. The blockchain is shown to include a primary block B1 including block data and a computed hash (from a hashing algorithm) for the primary block B1, a secondary block B2 including block data, a computed hash from the secondary block B2, and the computed hash of the previous block, and a tertiary block B3 including block data, a computed hash for the tertiary block B2, and the computing hash of the previous block. Fewer or more blocks including block data, computed hashes, and previous block hashes, are contemplated by and within the scope of this disclosure to be part of the blockchain as described herein.

The intelligent anomaly detection system 200 comprises the communication path 202. The communication path 202 may be formed from any medium that is capable of transmitting a signal such as, for example, conductive wires, conductive traces, optical waveguides, or the like, or from a combination of mediums capable of transmitting signals. The communication path 202 communicatively couples the various components of the intelligent anomaly detection system 200. As used herein, the term “communicatively coupled” means that coupled components are capable of exchanging data signals with one another such as, for example, electrical signals via conductive medium, electromagnetic signals via air, optical signals via optical waveguides, and the like.

The intelligent anomaly detection system 200 of FIG. 1 also comprises the processor 204. The processor 204 can be any device capable of executing machine readable instructions. Accordingly, the processor 204 may be a controller, an integrated circuit, a microchip, a computer, or any other computing device. The processor 204 is communicatively coupled to the other components of the intelligent anomaly detection system 200 by the communication path 202. Accordingly, the communication path 202 may communicatively couple any number of processors with one another, and allow the modules coupled to the communication path 202 to operate in a distributed computing environment. Specifically, each of the modules can operate as a node that may send and/or receive data.

The illustrated system 200 further comprises the memory component 206 which is coupled to the communication path 202 and communicatively coupled to the processor 204. The memory component 206 may be a non-transitory computer readable medium or non-transitory computer readable memory and may be configured as a nonvolatile computer readable medium. The memory component 206 may comprise RAM, ROM, flash memories, hard drives, or any device capable of storing machine readable instructions such that the machine readable instructions can be accessed and executed by the processor 204. The machine readable instructions may comprise logic or algorithm(s) written in any programming language such as, for example, machine language that may be directly executed by the processor, or assembly language, object-oriented programming (OOP), scripting languages, microcode, etc., that may be compiled or assembled into machine readable instructions and stored on the memory component 206. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Still referring to FIG. 1, as noted above, the intelligent anomaly detection system 200 in a distributed computing environment comprises nodes 208, which each may comprise a display such as a graphical user interface (GUI) on a screen of at least one computing device of a node for providing visual output such as, for example, information, graphical reports, messages, or a combination thereof. The communication path 202 communicatively couples the display to other modules of the intelligent anomaly detection system 200. The display can comprise any medium capable of transmitting an optical output such as, for example, a cathode ray tube, light emitting diodes, a liquid crystal display, a plasma display, or the like. Additionally, it is noted that the computing device can comprise at least one of the processor 204 and the memory component 206.

The intelligent anomaly detection system 200 comprises the AI tool 212 as described above to at least apply data artificial intelligence algorithms and models such as the AI model 212A as described herein, and the machine learning module 216 for providing such artificial intelligence algorithms and models. The machine learning module 216 may include an artificial intelligence component to automatically, and after the AI tool 212 is implemented, train the AI tool 212 and provide machine learning capabilities via machine learning techniques to a neural network such as the AI model 212A as described herein.

By way of example, and not as a limitation, the neural network may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hidden activation layers such as a linear function, a step function, logistic (sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error. In machine learning applications, new inputs may be provided (such as the generated one or more outputs) to the ANN model as training data to continue to improve accuracy and minimize error of the ANN model. The one or more ANN models may utilize one to one, one to many, many to one, and/or many to many (e.g., sequence to sequence) sequence modeling. The intelligent anomaly detection system 200 may utilize one or more ANN models as understood to those skilled in the art or as yet-to-be-developed to generate disturbance labels and alerts as described in embodiments herein. Such ANN models may include artificial intelligence components selected from the group that may include, but not be limited to, an artificial intelligence engine, Bayesian inference engine, and a decision-making engine, and may have an adaptive learning engine further comprising a deep neural network learning engine. The one or more ANN models may employ a combination of artificial intelligence techniques, such as, but not limited to, Deep Learning, Random Forest Classifiers, Feature extraction from audio, images, clustering algorithms, or combinations thereof.

In embodiments, a convolutional neural network (CNN) may be utilized. For example, a convolutional neural network (CNN) may be used as an ANN that, in a field of machine learning, for example, is a class of deep, feed-forward ANNs applied for audio-visual analysis of the captured disturbances. CNNs may be shift or space invariant and utilize shared-weight architecture and translation invariance characteristics. Additionally or alternatively, a recurrent neural network (RNN) may be used as an ANN that is a feedback neural network. RNNs may use an internal memory state to process variable length sequences of inputs to generate one or more outputs. In RNNs, connections between nodes may form a DAG along a temporal sequence. One or more different types of RNNs may be used such as a standard RNN, a Long Short Term Memory (LSTM) RNN architecture, and/or a Gated Recurrent Unit RNN architecture.

The AI tool 212, the AI model 212A, and the machine learning module 216 are coupled to the communication path 202 and communicatively coupled to the processor 204. As will be described in further detail below, the processor 204 may process the input signals received from the system modules and/or extract information from such signals.

Data stored and manipulated in the intelligent anomaly detection system 200 as described herein is utilized by the machine learning module 216, which in embodiments able to leverage a cloud computing-based network configuration such as the cloud to apply machine learning and artificial intelligence or may be able to rely on an internal architecture to apply machine learning and artificial intelligence as described herein. This machine learning application may create models that can be applied by the intelligent machine learning to make it more efficient and intelligent in execution. As an example and not a limitation, the machine learning module 216 may include artificial intelligence components selected from the group consisting of an artificial intelligence engine, Bayesian inference engine, and a decision-making engine, and may have an adaptive learning engine further comprising a deep neural network learning engine.

The intelligent anomaly detection system 200 comprises the network interface hardware 218 for communicatively coupling the intelligent anomaly detection system 200 with a computer network such as network 222. The network interface hardware 218 is coupled to the communication path 202 such that the communication path 202 communicatively couples the network interface hardware 218 to other modules of the intelligent anomaly detection system 200. The network interface hardware 218 can be any device capable of transmitting and/or receiving data via a wireless network. Accordingly, the network interface hardware 218 can comprise a communication transceiver for sending and/or receiving data according to any wireless communication standard. For example, the network interface hardware 218 can comprise a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

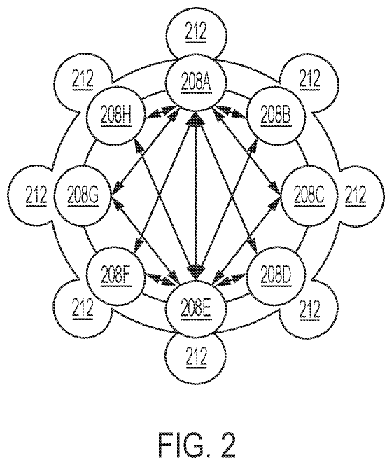

The intelligent anomaly detection system 200 can comprise multiple servers containing one or more applications and computing devices. Each computing device may include digital systems and other devices permitting connection to and navigation of the network 222. It is contemplated and within the scope of this disclosure that the computing device may be a personal computer, a laptop device, a mobile smart device such as a smartphone or smart pad or tablet, or the like. Other intelligent anomaly detection system 200 variations allowing for communication between various geographically diverse components are possible. The lines depicted in FIG. 2 indicate communication rather than physical connections between the various components.

The network 222 can comprise any wired and/or wireless network such as, for example, wide area networks, metropolitan area networks, the internet, an intranet, satellite networks, or the like. Accordingly, the network 222 can be utilized as a wireless access point by any computing device to access one or more servers that generally comprise processors, memory, and chipset for delivering resources via the network 222. Resources can include providing, for example, processing, storage, software, and information from the server 220 to the intelligent anomaly detection system 200 via the network 222. Additionally, it is noted that the server 220 and any additional servers can share resources with one another over the network 222 such as, for example, via the wired portion of the network, the wireless portion of the network, or combinations thereof. While the intelligent anomaly detection system 200 is illustrated as a single, integrated system in FIG. 1, in other embodiments, the systems can be independent systems.

In embodiments, the intelligent anomaly detection system 200 of FIG. 1 may be communicatively to a “big data” environment including the database 214 configured to store and process large volumes of data in such an environment to communicate with one or more external devices, systems, or application tools across technical platforms. The database 214 may be, for example, a structured query language (SQL) database or a like database that may be associated with a relational database management system (RDBMS) and/or an object-relational database management system (ORDBMS). The database 214 may be any other large-scale storage and retrieval mechanism whether a SQL, SQL including, or a non-SQL database. For example, the database 214 may utilize one or more big data storage computer architecture solutions. Such big data storage solutions may support large data sets in a hyperscale and/or distributed computing environment, which may, for example, include a variety of servers utilizing direct-attached storage (DAS). Such database environments may include Hadoop, NoSQL, and Cassandra that may be usable as analytics engines. Thus, while SQL may be referenced herein as an example database that is used with the tool described herein, it is understood that any other such type of database capable of support large amounts of database, whether currently available or yet-to-be developed, and as understood to those of ordinary skill in the art, may be utilized with the tool described herein as well.

Referring to FIG. 2, a blockchain network is illustrated including a plurality of nodes 208 as nodes 208A-208H, and the AI tool 212 communicatively coupled to each node 208. The AI tool 212 may be implemented and stored within one or more of the nodes 208. Thus, the AI tool 212 may have direct access to block data memory to execute at sub-second speeds. Additionally or alternatively, the AI tool 212 may be hosted remote from one or more of the nodes 208 of the blockchain network. When remote, the AI model may receive the block parameters extracted from the block of the blockchain via one or more internet protocols. Each node 208 may be a mining node configured to conduct proof of work to validate a block and compute a hash for the block upon successful validation by the mining node.

Referring to FIG. 3, a process 300 is shown for use with the intelligent anomaly detection system 200 of FIG. 1. The intelligent anomaly detection system 200 of FIG. 1, used to identify blockchain anomalies, may include the AI tool 212 comprising a processor 204 and an AI model 212A, a memory 206 communicatively coupled to the processor 204, and machine-readable instructions stored in the memory 206. Upon execution by the processor 204, the machine-readable instructions may cause the processor to perform a control scheme, such as the process 300 including blocks 302-308 and as further described below.

In block 302, block parameters are extracted from a block of a blockchain (such as any of blocks B1, B2, B3 in FIG. 1). In block 304, one or more statistical approximations of the block are generated based on the block parameters that are extracted from the block. In embodiments, block parameters may be extracted from a plurality of blocks include the block of the blockchain, and one or more statistical approximations of each block of the plurality of blocks may be generated based on the respective block parameters. Block parameters may be extracted directly from a blockchain computing node (BCN) 208, such as from a miner's own computing unit memory. Additionally or alternatively, block parameters may be extracted from a Blockchain Archive Node (BAN). The BAN is still considered part of the blockchain network, and the BAN receives Blocks after they get processed (i.e., hashed) at BCN. A sync delay time between BAN and the blockchain network is negligible, and the BAN can be designed to host the AI model 212A as one of its native algorithms, such as part of its Operating System (OS). Block data can be received externally from the BCN and/or the BAN, and the data transportation speed can be governed by AI model's external host internet speed. The block data may come as bytes or encrypted data (such as in an ‘extraData’ parameter). A Data Extraction processor in the AI tool 212 may use a Python package called Web3 API to convert the block data into a Unix and/or human readable format. Another Python package called Pandas may also be used for data type conversion.

Block parameters are thus extracted from block information and provided with statistical analysis to generate statistical approximations to enhance pattern visibility and determine any anomalies such as non-normal patterns in the statistical analysis (e.g., mean, standard deviation, and/or other regression analysis of the digital ledger of the block) by the AI tool as trained. Quantifying the block parameters (e.g., market parameters such as transactions volume, type (sell/buy), or gas price associated with cryptocurrency in a blockchain network) gives the AI tool 212 the ability to observe their values while changing in real-time to detect any sudden movement/behavior as a market anomaly within a sub-second interval to notify a consumer before the block gets computed.

In embodiments, the one or more statistical approximations of the block are compared to at least one anomaly threshold. An irregular block pattern in the block is detected when the one or more statistical approximations exceed the at least one anomaly threshold. A scoring process may be created during training where the model is trained to distinguish between blocks classified as normal that contain legitimate transactions from real users and blocks that contain illegitimate transactions, such as those made by a hacker. Thereafter, a statistical analyses conducted by the trained model on a block can be configured to detect whether there is any deviation from the analyses results associated with the normal blocks of the training data set and, if so, label the block as not normal and classify the block as an anomaly. Hence, there are two scores the model is trained on, one scoring set (such as a range) to be classified as normal and an outlying scoring set (i.e., outside of the normal range) to be classified as an anomaly.

In embodiments, selected block parameters may be used in statistical approximations to produce more input features to the AI model 212A. Such statistical approximations, such as calculated probability distribution, standard deviations and means, can create dynamical features that adapt and/or scale with the dynamicity (e.g., change in time) of the block parameters, such as of a gas price's change in time as a block/market parameter.

When analyzing a plurality of blocks in real-time, the one or more statistical approximations of each block of the plurality of blocks may be combined into a prediction set. The at least one statistical approximation of the prediction set may be compared to the at least one anomaly threshold, and the irregular block pattern may be detected when the at least one statistical approximation exceeds the at least one anomaly threshold. One or more blocks of the plurality of blocks containing the irregular block pattern may be determined, and, as described in greater detail below, via the AI model, an anomaly within the one or more blocks may be identified based on the irregular block pattern.

In block 306, via the AI tool 212, an anomaly is identified on the block based on the one or more statistical approximations when detecting the irregular block pattern in the block. In embodiments, the AI model 212A is trained based on a training set of data to generate one or more classifiers of types of anomalies, and the anomaly is identified based on one of the one or more classifiers. The one or more classifiers may include a classification of a phishing anomaly, a fraud anomaly, a financial fraud anomaly, or combinations thereof. The financial fraud anomaly may be based on an extreme fluctuation over a transaction pattern threshold of gas price transaction pattern, a sell/buy transaction pattern, or combinations thereof. The classifiers of the AI tool 212 may be created using deep learning and/or machine learning models with accuracy and performance benchmarks measured upon successful clustering of types of anomalies into targeted classifications. The blockchain training data may be specifically directed to the purpose associated with the classifiers, such as phishing/fraud anomalies blockchain training data or financial blockchain training data (e.g., gas price or sell/buy transactions volume data showing sudden changes above an acceptable threshold in a period of time).

In embodiments, training of the AI model 212A is based on information collected directly from blocks within the blockchain network. Historical blocks data may be collected from a blockchain archive node, cleaned, and several mathematical approximations may be carried on features of the data. Natural Language Processing may also be used to process features of the block. Machine Learning Classification Models, such as Isolation Forest, Local Outlier Factor, and K-Nearest Neighbors may be used along with Deep Learning Models, such Graph Neural Network, Neural Networks, and Autoencoders.

Regarding phishing activities, the AI tool 212 can scan the block parameters and classify the block as an anomaly if phishing address are included and the AI tool detects modifications over an acceptable threshold or otherwise identified as a non-normal pattern that a phishing address introduces to the block parameter approximations. For example, the AI tool 212 is trained to identify a number of transactions executed by a phishing address along with respective amounts values for situations in which attackers steal coins (e.g., cryptocurrency such as BITCOIN, ETHEREUM) from different victims addresses to dispose the coins into multiple fake addresses that belong to the attacker.

In block 308, an alert is generated when the anomaly is identified. Once the anomaly is identified, the alert may be sent out to the intelligent anomaly detection system 200, to a user associated with the block, or combinations thereof. For example, a user may be informed via a technical platform that a fraudulent transaction has been attempted, and the user may then cancel the transaction. The technical platform may include messaging technology such as a text, email, voice call, push notification on a display of a mobile smart device, or combinations thereof. Additionally or alternatively, the AI tool 212 itself may instruct an associated system to automatically prevent or hold the transaction including the anomaly.

In embodiments, the AI tool 212 may be combined with other AI prediction techniques such as Deep Learning prediction technique to predict and improve an accuracy of predictions by providing anomalies information about the block and generating associated dynamic features to feed into the prediction algorithm (e.g., of market trends) as inputs. Further, the AI tool 212 and AI model 212A may be implemented within blockchain network nodes 208 to have a direct access to block data in-memory or may be hosted externally outside the blockchain network and have data fed in such as via internet protocols. The AI tool 212 described herein may be trained to detect and classify anomalies within a block in real-time, such as during and within a time period a hash is being computed for the block, by extracting block parameters and applying a statistical analysis to the block as a whole at a non-transaction level determine non-normal patterns associated with non-user and non-transaction specific extracted block parameters to determine whether fraud or other invalid transactions are associated with the block.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is also noted that recitations herein of “at least one” component, element, etc., should not be used to create an inference that the alternative use of the articles “a” or “an” should be limited to a single component, element, etc.

It is noted that recitations herein of a component of the present disclosure being “configured” or “programmed” in a particular way, to embody a particular property, or to function in a particular manner, are structural recitations, as opposed to recitations of intended use.

It is noted that terms like “preferably,” “commonly,” and “typically,” when utilized herein, are not utilized to limit the scope of the claimed disclosure or to imply that certain features are critical, essential, or even important to the structure or function of the claimed disclosure. Rather, these terms are merely intended to identify particular aspects of an embodiment of the present disclosure or to emphasize alternative or additional features that may or may not be utilized in a particular embodiment of the present disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. A system to identify blockchain anomalies, the system comprising:
an artificial intelligence (AI) tool comprising a processor and an AI model;
a memory communicatively coupled to the processor; and
machine-readable instructions stored in the memory that, upon execution by the processor, cause the processor to:
extract block parameters from a block of a blockchain;
generate one or more statistical approximations of the block based on the block parameters;
compare the one or more statistical approximations of the block to at least one anomaly threshold;
detect an irregular block pattern in the block when the one or more statistical approximations exceed the at least one anomaly threshold;
via the AI model, identify an anomaly within the block based on the irregular block pattern in the block; and
generate an alert when the anomaly is identified.

2. The system of claim 1, wherein the machine-readable instructions further cause the processor to:
train the AI model based on a training set to generate one or more classifiers of types of anomalies; and
identify the anomaly based on one of the one or more classifiers.

3. The system of claim 2, wherein the one or more classifiers comprise a classification of a phishing anomaly, a fraud anomaly, a financial fraud anomaly, or combinations thereof.

4. The system of claim 3, wherein the financial fraud anomaly is based on an extreme fluctuation over a transaction pattern threshold of gas price transaction pattern, a sell/buy transaction pattern, or combinations thereof.

5. The system of claim 1, wherein the AI model is implemented in one or more nodes of the blockchain.

6. The system of claim 1, wherein the AI model is hosted remote from and communicatively coupled to one or nodes of the blockchain.

7. The system of claim 6, wherein the AI model receives the block parameters extracted from the block of the blockchain via one or more internet protocols.

8. The system of claim 1, wherein the machine-readable instructions further cause the processor to:
extract block parameters from a plurality of blocks include the block of the blockchain; and
generate one or more statistical approximations of each block of the plurality of blocks based on the respective block parameters.

9. The system of claim 8, wherein the machine-readable instructions further cause the processor to:
combine the one or more statistical approximations of each block of the plurality of blocks into a prediction set;
compare at least one statistical approximation of the prediction set to the at least one anomaly threshold;
detect the irregular block pattern when the at least one statistical approximation exceeds the at least one anomaly threshold.

10. The system of claim 9, wherein the machine-readable instructions further cause the processor to:
determine one or more blocks of the plurality of blocks containing the irregular block pattern; and
via the AI model, identify an anomaly within the one or more blocks based on the irregular block pattern.

11. A system to identify blockchain anomalies, the system comprising:
an artificial intelligence (AI) tool comprising a processor and an AI model;
a memory communicatively coupled to the processor; and
machine-readable instructions stored in the memory that, upon execution by the processor, cause the processor to:
extract block parameters from a plurality of blocks of a blockchain;
generate one or more statistical approximations of each block of the plurality of blocks based on the respective block parameters;
detect an irregular block pattern in the block when the one or more statistical approximations exceed at least one anomaly threshold;
determine one or more blocks of the plurality of blocks containing the irregular block pattern;
via the AI model, identify an anomaly within the one or more blocks based on the irregular block pattern; and
generate an alert when the anomaly is identified.

12. The system of claim 11, wherein the machine-readable instructions further cause the processor to:
combine the one or more statistical approximations of each block of the plurality of blocks into a prediction set;
compare at least one statistical approximation of the prediction set to at least one anomaly threshold; and
detect the irregular block pattern in the block when the at least one statistical approximation exceeds the at least one anomaly threshold.

13. The system of claim 11, wherein the machine-readable instructions further cause the processor to:
train the AI model based on a training set to generate one or more classifiers of types of anomalies; and
identify the anomaly based on one of the one or more classifiers.

14. The system of claim 13, wherein the one or more classifiers comprise a classification of a phishing anomaly, a fraud anomaly, a financial fraud anomaly, or combinations thereof.

15. The system of claim 14, wherein the financial fraud anomaly is based on an extreme fluctuation over a transaction pattern threshold of gas price transaction pattern, a sell/buy transaction pattern, or combinations thereof.

16. The system of claim 11, wherein the AI model is implemented in one or more nodes of the blockchain.

17. The system of claim 11, wherein the AI model is hosted remote from and communicatively coupled to one or nodes of the blockchain.

18. The system of claim 17, wherein the AI model receives the block parameters extracted from the block of the blockchain via one or more internet protocols.

19. A method to identify blockchain anomalies, the method comprising:
extracting block parameters from a block of a blockchain;
generating one or more statistical approximations of the block based on the block parameters;
comparing the one or more statistical approximations of the block to at least one anomaly threshold;
detecting an irregular block pattern in the block when the one or more statistical approximations exceed the at least one anomaly threshold;
via an artificial intelligence (AI) model, identifying an anomaly within the block based on the irregular block pattern in the block; and
generating an alert when the anomaly is identified.

20. The method of claim 19, further comprising:
training the AI model based on a training set to generate one or more classifiers of types of anomalies; and
identifying the anomaly based on one of the one or more classifiers.
